(19) United States
(12) Patent Application Publication
(10) Pub. No.: US 2024/0333695 A1
(43) Pub. Date: Oct. 3, 2024

(54) SECURE DEVICE PAIRING

(71) Applicant: Lenovo (Singapore) Pte. Ltd., New Tech Park (SG)

(72) Inventors: Igor Stolbikov, Apex, NC (US); Rod D. Waltermann, Rougemont, NC (US); Sergei Rodionov, Plano, TX (US); Scott Li, Cary, NC (US)

(21) Appl. No.: 18/194,528

(22) Filed: Mar. 31, 2023

(51) Int. Cl. H04L 9/40; H04L 9/32

(52) U.S. Cl. CPC H04L 63/061; H04L 9/3263; H04L 63/0876

(57) ABSTRACT

Apparatuses, methods, systems, and program products are disclosed for secure device pairing. An apparatus includes a processor and a memory that stores code executable by the processor. The code is executable by the processor to receive, at the apparatus during a secure pairing process with a second computing device, a first key associated with the second computing device, generate a digital certificate based on a dynamically generated key pair associated with the apparatus, calculate a digital fingerprint for the apparatus based on the first key associated with the second computing device and at least one of the keys of the key pair associated with the apparatus, and transmit, to the second computing device, the generated digital certificate and the digital fingerprint to establish a secure network connection with the second computing device.

### FIELD

The subject matter disclosed herein relates to computing systems and more particularly relates to secure device pairing.

### BACKGROUND

Computing devices and/or applications executing on the computing devices may communicate over a computer network. To maintain data integrity, privacy, security, confidentiality, and/or the like, a secure or trusted network connection may be established between devices.

### BRIEF SUMMARY

An apparatus for secure device pairing is disclosed. A method and program product also perform the functions of the apparatus.

In one embodiment, an apparatus includes a processor and a memory that stores code executable by the processor. In one embodiment, the code is executable by the processor to receive, at the apparatus during a secure pairing process with a second computing device, a first key associated with the second computing device, generate a digital certificate based on a dynamically generated key pair associated with the apparatus, calculate a digital fingerprint for the apparatus based on the first key associated with the second computing device and at least one of the keys of the key pair associated with the apparatus, and transmit, to the second computing device, the generated digital certificate and the digital fingerprint to establish a secure network connection with the second computing device.

In one embodiment, a method receives, at a first computing device during a secure pairing process with a second computing device, a first key associated with the second computing device, generates a digital certificate based on a dynamically generated key pair associated with the first computing device, calculates a digital fingerprint for the first computing device based on the first key associated with the second computing device and at least one of the keys of the key pair associated with the first computing device, and transmits, to the second computing device, the generated digital certificate and the digital fingerprint to establish a secure network connection with the second computing device.

In one embodiment, a program product includes a computer readable storage medium that stores code executable by a processor. In one embodiment, the code is executable by the processor to receive, at a first computing device during a secure pairing process with a second computing device, a first key associated with the second computing device, generate a digital certificate based on a dynamically generated key pair associated with the first computing device, calculate a digital fingerprint for the first computing device based on the first key associated with the second computing device and at least one of the keys of the key pair associated with the first computing device, and transmit, to the second computing device, the generated digital certificate and the digital fingerprint to establish a secure network connection with the second computing device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for secure device pairing in accordance with the subject matter disclosed herein;

FIG. 2 is a schematic block diagram illustrating one embodiment of an apparatus for secure device pairing in accordance with the subject matter disclosed herein;

FIG. 3 is a schematic block diagram illustrating one embodiment of a procedure flow for secure device pairing in accordance with the subject matter disclosed herein;

FIG. 4 is a schematic block diagram illustrating one embodiment of an apparatus for secure device pairing in accordance with the subject matter disclosed herein;

FIG. 5 is a schematic flow chart diagram illustrating one embodiment of a method for secure device pairing in accordance with the subject matter disclosed herein; and

FIG. 6 is a schematic flow chart diagram illustrating one embodiment of another method for secure device pairing in accordance with the subject matter disclosed herein.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

In one embodiment, an apparatus includes a processor and a memory that stores code executable by the processor. In one embodiment, the code is executable by the processor to receive, at the apparatus during a secure pairing process with a second computing device, a first key associated with the second computing device, generate a digital certificate based on a dynamically generated key pair associated with the apparatus, calculate a digital fingerprint for the apparatus based on the first key associated with the second computing device and at least one of the keys of the key pair associated with the apparatus, and transmit, to the second computing device, the generated digital certificate and the digital fingerprint to establish a secure network connection with the second computing device.

In one embodiment, the code is further executable by the processor to receive, from the second computing device, a second digital certificate and a second digital fingerprint associated with the second computing device, verify the second digital certificate and the second digital fingerprint based on the first key and the key pair, and establish, in response to verifying the second the second digital certificate and the second digital fingerprint, the secure network connection with the second computing.

In one embodiment, the code is further executable by the processor to associate a validity time period with at least one of the key pair and the calculated digital fingerprint for the apparatus.

In one embodiment, the code is further executable by the processor to invalidate the at least one of the key pair and the calculated digital fingerprint for the apparatus in response to expiration of the validity time period.

In one embodiment, invalidation of the at least one of the key pair and the calculated digital fingerprint for the apparatus disconnects the secure network connection with the second computing device.

In one embodiment, the code is further executable by the processor to invalidate the at least one of the key pair and the calculated digital fingerprint for the apparatus in response to disconnection of the secure network connection with the second computing device.

In one embodiment, the secure pairing process is between a first plugin executing on the apparatus and a second plugin executing on the second computing device.

In one embodiment, in response to a request to initiate the secure pairing process with the second computing device, the code is further executable by the processor to generate the key pair for the apparatus, the key pair comprising a public key and a private key.

In one embodiment, the code is further executable by the processor to transmit the public key for the apparatus to the second computing device.

In one embodiment, the code is further executable by the processor to calculate a shared secret seed using a key agreement protocol between the apparatus and the second computing device, the key agreement protocol comprising an elliptic curve cryptography protocol.

In one embodiment, the code is further executable by the processor to calculate a second key based on identifiers for the apparatus and the second computing device.

In one embodiment, the code is further executable by the processor to generate the digital certificate using a key generated using elliptic curve cryptography (“ECC”) based on the second key and a dynamically determined generator ECC point.

In one embodiment, the secure pairing process comprises a mutual transport layer security (“mTLS”) protocol.

In one embodiment, a method receives, at a first computing device during a secure pairing process with a second computing device, a first key associated with the second computing device, generates a digital certificate based on a dynamically generated key pair associated with the first computing device, calculates a digital fingerprint for the first computing device based on the first key associated with the second computing device and at least one of the keys of the key pair associated with the first computing device, and transmits, to the second computing device, the generated digital certificate and the digital fingerprint to establish a secure network connection with the second computing device.

In one embodiment, the method receives, from the second computing device, a second digital certificate and a second digital fingerprint associated with the second computing device, verifies the second digital certificate and the second digital fingerprint based on the first key and the key pair, and establishes, in response to verifying the second the second digital certificate and the second digital fingerprint, the secure network connection with the second computing.

In one embodiment, the method associates a validity time period with at least one of the key pair and the calculated digital fingerprint for the apparatus.

In one embodiment, the method invalidates the at least one of the key pair and the calculated digital fingerprint for the apparatus in response to expiration of the validity time period.

In one embodiment, invalidation of the at least one of the key pair and the calculated digital fingerprint for the apparatus disconnects the secure network connection with the second computing device.

In one embodiment, the method invalidates the at least one of the key pair and the calculated digital fingerprint for the apparatus in response to disconnection of the secure network connection with the second computing device.

In one embodiment, the secure pairing process is between a first plugin executing on the apparatus and a second plugin executing on the second computing device.

In one embodiment, in response to a request to initiate the secure pairing process with the second computing device, the method generates the key pair for the apparatus, the key pair comprising a public key and a private key.

In one embodiment, the transmits the public key for the apparatus to the second computing device.

In one embodiment, the method calculates a shared secret seed using a key agreement protocol between the apparatus and the second computing device, the key agreement protocol comprising an elliptic curve cryptography protocol.

In one embodiment, the method calculates a second key based on identifiers for the apparatus and the second computing device.

In one embodiment, the method generates the digital certificate using a key generated using ECC based on the second key and a dynamically determined generator ECC point. In one embodiment, the secure pairing process comprises an mTLS protocol.

In one embodiment, a program product includes a computer readable storage medium that stores code executable by a processor. In one embodiment, the code is executable by the processor to receive, at a first computing device during a secure pairing process with a second computing device, a first key associated with the second computing device, generate a digital certificate based on a dynamically generated key pair associated with the first computing device, calculate a digital fingerprint for the first computing device based on the first key associated with the second computing device and at least one of the keys of the key pair associated with the first computing device, and transmit, to the second computing device, the generated digital certificate and the digital fingerprint to establish a secure network connection with the second computing device.

In one embodiment, the code is further executable by the processor to receive, from the second computing device, a second digital certificate and a second digital fingerprint associated with the second computing device, verify the second digital certificate and the second digital fingerprint based on the first key and the key pair, and establish, in response to verifying the second the second digital certificate and the second digital fingerprint, the secure network connection with the second computing.

In one embodiment, the code is further executable by the processor to associate a validity time period with at least one of the key pair and the calculated digital fingerprint for the apparatus.

In one embodiment, the code is further executable by the processor to invalidate the at least one of the key pair and the calculated digital fingerprint for the apparatus in response to expiration of the validity time period.

In one embodiment, invalidation of the at least one of the key pair and the calculated digital fingerprint for the apparatus disconnects the secure network connection with the second computing device.

In one embodiment, the code is further executable by the processor to invalidate the at least one of the key pair and the calculated digital fingerprint for the apparatus in response to disconnection of the secure network connection with the second computing device.

In one embodiment, the secure pairing process is between a first plugin executing on the apparatus and a second plugin executing on the second computing device.

In one embodiment, in response to a request to initiate the secure pairing process with the second computing device, the code is further executable by the processor to generate the key pair for the apparatus, the key pair comprising a public key and a private key.

In one embodiment, the code is further executable by the processor to transmit the public key for the apparatus to the second computing device.

In one embodiment, the code is further executable by the processor to calculate a shared secret seed using a key agreement protocol between the apparatus and the second computing device, the key agreement protocol comprising an elliptic curve cryptography protocol.

In one embodiment, the code is further executable by the processor to calculate a second key based on identifiers for the apparatus and the second computing device.

In one embodiment, the code is further executable by the processor to generate the digital certificate using a key generated using ECC based on the second key and a dynamically determined generator ECC point.

In one embodiment, the secure pairing process comprises an mTLS protocol.

In general, the subject matter disclosed herein is directed to embodiments for establishing a secure network connection between devices. In particular, this disclosure describes solutions for establishing a trusted, secure connection between plugins executing on a mesh network using ephemeral, ratchet pinned certificates. As used herein, a plugin may refer to a program, application, or other software add-on that is installed on a program or application (e.g., a web browser) to enhance or add capabilities.

To support an mTLS connection between devices or plugins digital certificates may be used such as X.509 certificates, which are a standard format for public key certificates-digital documents that securely associate cryptographic key pairs with identities such as websites, individuals, devices, or organizations.

However, some issues with X.509 certificate use and management in a mesh network may be that X.509 certificates need to be certificates need to be trusted by each device during the pairing/network joining process to support mTLS; devices may be not online to use a centralized certification authority; there is a need to provide support for certificates to untrusted plugins while preserving the trust; plugins may require private and public keys to establish mTLS; there may be a need for protection against plugins leaking and abusing certificate private key; and there may be a need to maintain the original trust established during pairing process.

Existing solutions to the foregoing problems may include using self-signed certificates with no trust, which is vulnerable to man-in-the-middle attacks; using public key infrastructure provided certificates, which are not practical or applicable for all use cases (e.g., in an airgap environment and for new third-party devices) and may be a source of private key leakage to untrusted third party plugins or other applications; and using separate out-of-band negotiation channels, which require a trust change for the security of communication.

The subject matter disclosed herein provides solutions and improvements over the foregoing problems using ephemeral, ratchet-pinned certificates with the trust from the initial pairing key. As described in more detail below, the new private key, public key, digital (e.g., X.509) certificate, and pairing device fingerprints are dynamically calculated and provided to the plugin for each mTLS connection request.

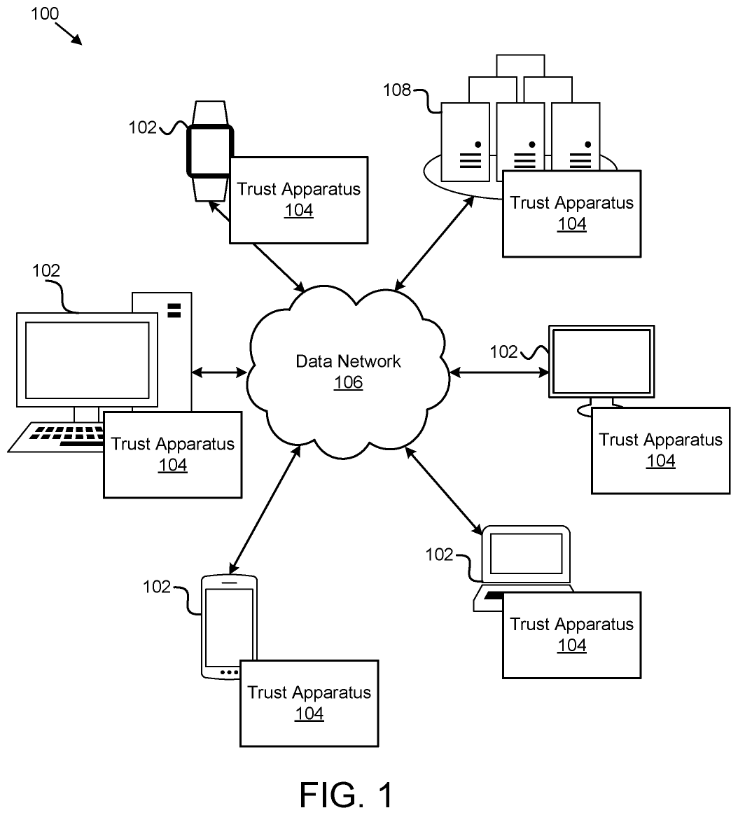

FIG. 1 is a schematic block diagram illustrating one embodiment of a system 100 for secure device pairing. In one embodiment, the system 100 includes one or more information handling devices 102, one or more trust apparatuses 104, one or more data networks 106, and one or more servers 108. In certain embodiments, even though a specific number of information handling devices 102, trust apparatuses 104, data networks 106, and servers 108 are depicted in FIG. 1, one of skill in the art will recognize, in light of this disclosure, that any number of information handling devices 102, trust apparatuses 104, data networks 106, and servers 108 may be included in the system 100.

In one embodiment, the system 100 includes one or more information handling devices 102, e.g., computing devices. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

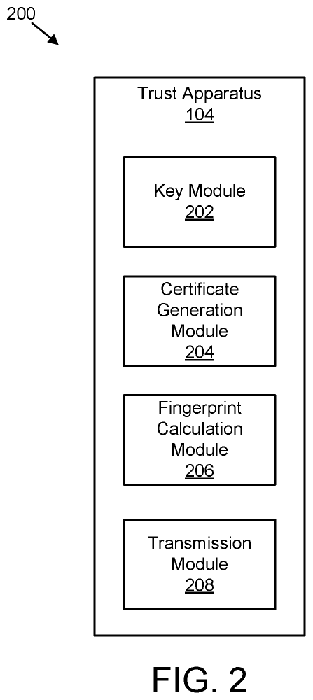

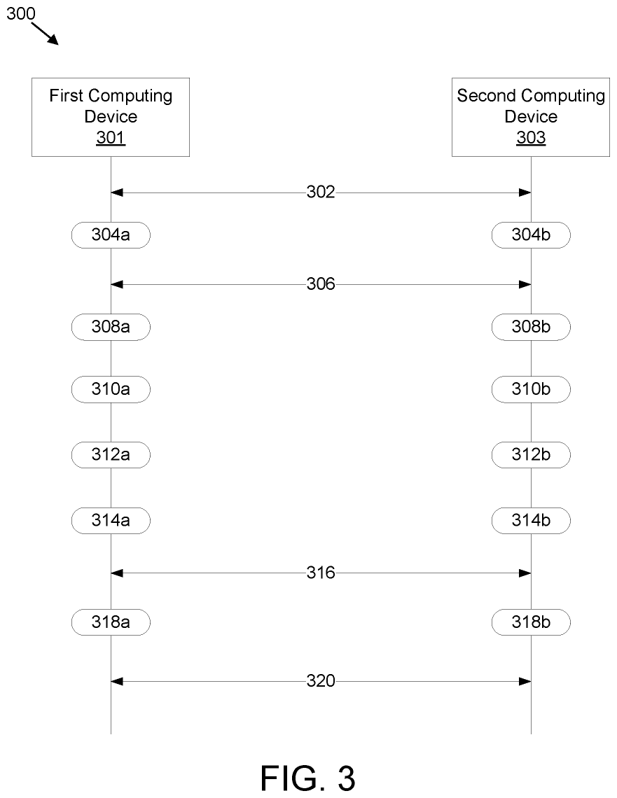

In general, in one embodiment, the trust apparatus 104 is configured to establish a secure network connection between two different computing devices using ephemeral, ratchet pinned digital certificates based on an initial pairing key. For instance, in one embodiment, the trust apparatus 104 on a first computing device receives a first key associated with a second computing device, generates a digital certificate based on a key pair associated with the first computing device, calculates a digital fingerprint for the first computing device based on the first key associated with the second computing device and at least one of the keys of the key pair associated with the first computing device, and transmits, to the second computing device, the generated digital certificate and the digital fingerprint to establish a secure network connection with the second computing device. In certain embodiments, the keys, certificates, fingerprints, or the like include a temporal or ephemeral aspect such that they expire after a predetermined amount of time, which may necessitate generation of the digital certificates and the digital fingerprints, based on a new key pair, to establish a new secure connection. The foregoing process, described in more detail below with reference to FIGS. 2 and 3, occurs in a mutual fashion between two or more devices to establish a secure network connection based on trust with or without a central certificate authority or other trust manager.

In certain embodiments, the trust apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the trust apparatus 104 may include a power interface, a wired and/or wireless network interface, a graphical interface that attaches to a display, and/or a semiconductor integrated circuit device as described below, configured to perform the functions described herein with regard to the trust apparatus 104.

The trust apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the trust apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the trust apparatus 104.

The semiconductor integrated circuit device or other hardware appliance of the trust apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the trust apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

In one embodiment, the data network 106 is a mesh network. As used herein, a mesh network is a local area network topology in which the infrastructure nodes (i.e. bridges, switches, and other infrastructure devices) connect directly, dynamically and non-hierarchically to as many other nodes as possible and cooperate with one another to efficiently route data to and from clients. This lack of dependency on one node allows for every node to participate in the relay of information.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102.

FIG. 2 is a schematic block diagram illustrating one embodiment of an apparatus 200 for secure device pairing. In one embodiment, the apparatus 200 includes an instance of a trust apparatus 104. In one embodiment, the trust apparatus 104 includes one or more of a key module 202, a certificate generation module 204, a fingerprint calculation module 206, and a transmission module 208, which are described in more detail below.

In one embodiment, the key module 202 is configured to generate one or more keys for use in establishing a secure network connection between a first computing device/plugin and a second computing device/plugin. For example, the key module 202 may generate a public/private cryptographic key pair. The key module 202 may generate the keys using various key generation algorithms such as ECC.

In response to initiating a secure device pairing process, the key module may receive, at the first computing device/plugin, during the secure pairing process with a second computing device/plugin (“the pairing device”), a first key associated with the second computing device. Furthermore, the key module 202 may transmit a first key associated with the first computing device/plugin to the second computing device/plugin. The first key may be a public key of a public/private key pair for the first and/or second computing devices/plugins.

In one embodiment, the key module 202 generates the one or more keys based on a plugin or other application, program, service, or the like executing on the computing device. In various embodiments, the key module 202 generates the one or more keys dynamically in response to initiation of a secure pairing process between computing devices. In one embodiment, the key module 202 may generate the same keys on the different computing devices establishing the secure connection, e.g., if based on the same seed, parameters, values, and/or the like and using the same cryptography scheme.

In one embodiment, the secure pairing process may include an mTLS process. As used herein, TLS may refer to a cryptographic protocol designed to provide communications security over a computer network. mTLS may refer to TLS connections where mutual authentication is required to ensure that the parties at each end of a network connection are who they claim to be by verifying that they both have the correct private key. The information within their respective TLS certificates provides additional verification.

In one embodiment, the certificate generation module 204 is configured to generate a digital certificate based on a dynamically generated key pair associated with the first computing device/plugin (which may be a different key pair than the key pair that the key module 202 initially generates). In such an embodiment, the key pair may be dynamically generated in response to initiation of the secure pairing process (explained in more detail below). The generated digital certificate may be a digital certificate issued by a certificate authority or may be a self-signed digital certificate.

As used herein, a self-signed digital certificate may refer to a public key certificate, also known as a digital certificate or identity certificate, that is an electronic document used to prove the validity of a public key without the use of a central certificate authority. The certificate may include information about the key, information about the identity of its owner (called the subject), and the digital signature of an entity that has verified the certificate's contents (called the issuer). If the signature is valid, and the software examining the certificate trusts the issuer, then it can use that key to communicate securely with the certificate's subject, e.g., the second computing device/plugin.

In one embodiment, the fingerprint calculation module 206 is configured to calculate a digital fingerprint for the first computing device/plugin based on the first key associated with the second computing device/plugin and at least one of the keys of the key pair associated with the first computing device/plugin. As used herein, a digital fingerprint may refer to a unique identifier for a computing device that is determined during a secure connection establishment process, e.g., based on the fields in its initial message (e.g., “Client Hello”) message during a TLS handshake.

In one embodiment, the transmission module 208 is configured to transmit, to the second computing device/plugin, the generated digital certificate and the digital fingerprint to establish a secure network connection with the second computing device/plugin. The second computing device/plugin, in one embodiment, verifies the digital certificate and the fingerprint of the first computing device/plugin, and if verified, establishes a secure network connection with the first computing device/plugin. The first computing device/plugin also receives and verifies the digital certificate of the second computing device/plugin and the fingerprint of the second computing device/plugin to complete the secure network connection establishment.

FIG. 3 depicts a procedure flow 300 for secure device pairing. In one embodiment, the first computing device/plugin 301 and/or the second computing device/plugin 303 initiates a secure pairing process (see messaging 302) to establish a secure network connection with the other device.

In one embodiment, in response to initiation of the secure pairing process (e.g., in response to a request to establish a secure network connection), the key module 202 on the first and second computing devices/plugins 301, 303 creates (see blocks 304a, 304b) a public/private key pair—(A, a) for the first computing device/plugin 301 and (B, b) for the second computing device/plugin 303.

In one embodiment, the key module 202 sends and receives (see messaging 306) the public keys for each of the first and second computing devices/plugins 301, 303—the key module 202 sends the public key (A) of the first computing device/plugin 301 to the second computing device/plugin 303, and the key module 202 sends the public key (B) of the second computing device/plugin 303 to the first computing device/plugin 301.

In one embodiment, on the first and second computing devices/plugins 301, 303, the certificate module 204 calculates (see blocks 308a, 308b) a shared secret seed using a key agreement protocol between the first computing device/plugin 301 and the second computing device/plugin 303. In one embodiment, the key agreement protocol is an elliptic curve cryptography protocol, e.g., an elliptic-curve Diffie-Hillman (“ECDH”) key agreement protocol, which allows two devices, each having an ECC public/private key pair, to establish a shared secret over an insecure channel.

For example, on the first computing device/plugin 301, the certificate module 204 calculates the shared secret seed k as k=ECDH (a, B) and on the second computing device/plugin 303, the certificate module 204 calculates the shared secret seed k as k=ECDH (b, A).

In one embodiment, on the first and second computing devices/plugins 301, 303, the certificate module 204 calculates (see blocks 310a, 310b), for each request, a dynamically generated key pair (x, k) based on identifiers for the first and the second computing devices/plugins 301, 303. In one embodiment, the identifiers may be for plugins running on the first and second computing devices 301, 303 and are attempting to establish the secure network connection. Thus, on the first and second computing devices/plugins 301, 303, the dynamically generated key pair (x, k) may be determined as [x=KDF (k, identifier1, identifier2), k=hash(x)], where KDF is a key derivation function that derives keys from other values. In this manner, a different x value is calculated for each device/plugin pair that is establishing the secure network connection.

In one embodiment, on the first and second computing devices/plugins 301, 303, the certificate module 204 generates (see blocks 312a, 312b) the digital certificate using a key pair that is generated using ECC based on x and a dynamically determined generator ECC point, G. For instance, on the first computing device/plugin 301, the certificate module 204 generates a private/public key pair for the digital certificate as a(i)=a*x*/mod n, A(i)=a(i)*G. Similarly, on the second computing device/plugin 303, the certificate module 204 generates a private/public key pair for the digital certificate as b(i)=b*x*/mod n, B(i)=b(i)*G.

In one embodiment, on the first and second computing devices/plugins 301, 303, the fingerprint calculation module 206 calculates (see blocks 314a, 314b) a digital fingerprint for the first and second computing devices/plugins 301, 303. For instance, the fingerprint calculation module 206 on the first computing device/plugin 301 may calculate the digital fingerprint as B(i)=hash(B*x*/mod n) and the fingerprint calculation module 206 on the second computing device/plugin 303 may calculate the digital fingerprint as A(i)=hash(A*x*/mod n).

As used herein, n may represent a value of a finite field, which may refer to a field that contains a finite number of elements, e.g., a set on which the operations of multiplication, addition, subtraction and division are defined and satisfy certain basic rules. Here, in one example, n may be the largest prime number in the set, e.g., in secp256k1, n may be the largest prime that is smaller than 2²⁵⁶.

In one embodiment, the transmission module 208 on the first and second computing devices/plugins 301, 303 transmits (see messaging 316) the digital certificates and the digital fingerprint for each computing device/plugin 301, 303, where they are verified (see blocks 318a, 318b) and, if successful, a secure network connection is established (see messaging 320) between the first and second computing devices/plugins 301, 303.

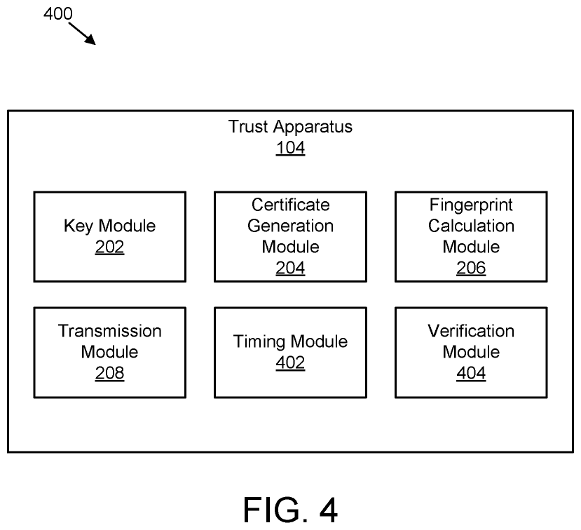

FIG. 4 is a schematic block diagram illustrating one embodiment of an apparatus 400 for secure device pairing. In one embodiment, the apparatus 400 includes an instance of a trust apparatus 104. In one embodiment, the trust apparatus 104 includes one or more of a key module 202, a certificate generation module 204, a fingerprint calculation module 206, and a transmission module 208, may be substantially similar to the key module 202, the certificate generation module 204, the fingerprint calculation module 206, and the transmission module 208 described above with reference to FIG. 2. In further embodiments, the trust apparatus 104 includes a timing module 402 and a verification module 404, which are described in more detail below.

In one embodiment, the timing module 402 is configured to associate a validity time period with at least one of the key pair and the calculated digital fingerprint. The validity time period may be on the order of seconds, minutes, hours, or days. For instance, the validity time period may be 24 hours, meaning that the keys, digital certificates, and/or digital fingerprints are valid for 24 hours, or however long the validity time period is.

In such an embodiment, upon expiration of the validity time period, e.g., after 24 hours has passed, the keys, digital certificates, and/or the digital fingerprints are invalidated and the secure network connection between the first and second computing devices/plugins is disconnected. Upon disconnection, if the first and second computing devices/plugins desire to reconnect, new keys, digital certificates, and/or digital fingerprints will need to be calculated or generated to initiate a new secure pairing process and establish a trusted, secure network connection between the first and second devices/plugins.

In one embodiment, continuing with the procedure flow of FIG. 3, the timing module 402 adds a time-based factor (e.g., the validity time period) to the private key for the first computing device/plugin 301 as a(i)=a*x*(time_period)/mod n. Similarly, for the second computing device/plugin 303, the timing module 402 adds a time-based factor as b(i)=b*x*(time_period)/mod n. The “time_period” may be calculated as time_in_msec/msec_in_period.

The timing module 402 may also add a time-based factor to the digital fingerprint. For instance, for the first computing device/plugin 301, the time-based factor may be incorporated as B(i)=hash(B*x*/(time_period)/mod n), and for the second computing device/plugin 303, the time-based factor may be incorporated as A(i)=hash(A*x*/(time_period)/mod n).

In this manner, the keys, digital certificates, and the digital fingerprints have a limited lifetime before they expire and new keys, digital certificates, and digital fingerprints need to be generated/calculated to establish a new trusted, secure connected between devices/plugins. Further, the addition of the validity time period (time-based factor) adds additional level of protection by invalidating the keys, digital certificates, and the digital fingerprints outside the validity time period. In certain embodiments, when the secure network connection between the first and second computing devices/plugins is disconnected, the keys, digital certificates, and/or the digital fingerprints are invalidated, requiring a new secure pairing process to be performed to reestablish the secure network connection between the first and second computing devices/plugins.

In one embodiment, the verification module 404, in one embodiment, is configured to verify the digital certification and/or the digital fingerprint received from a device/plugin that wants to establish a secure network connection. In such an embodiment, the verification module 404 may verify the digital certificate and the digital fingerprint using the key information from the pairing device to ensure that these items match or otherwise correspond to each other. In response to a successful verification, on both devices/plugins, the devices establish a trusted, secure network connection.

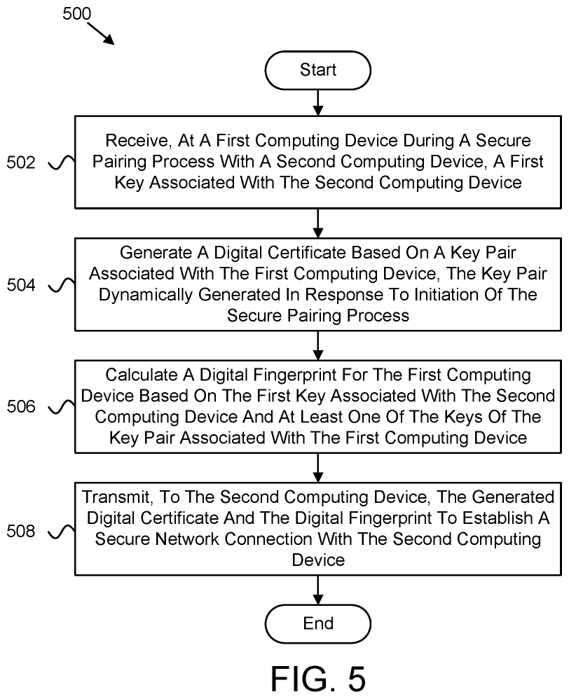

FIG. 5 is a schematic flow chart diagram illustrating one embodiment of a method 500 for secure device pairing. In one embodiment, the method 500 is performed by an information handling device 102, a plugin, a trust apparatus 104, a key module 202, a certificate generation module 204, a fingerprint calculation module 206, a transmission module 208, a timing module 402, a verification module 404, an FPGA, an ASIC, and/or any other computing device.

In one embodiment, the method 500 begins and receives 502, at a first computing device during a secure pairing process with a second computing device, a first key associated with the second computing device. In one embodiment, the method 500 generates 504 a digital certificate based on a key pair associated with the first computing device, the key pair dynamically generated in response to initiation of the secure pairing process. In one embodiment, the method 500 calculates 506 a digital fingerprint for the first computing device based on the first key associated with the second computing device and at least one of the keys of the key pair associated with the first computing device. In one embodiment, the method 500 transmits 508, to the second computing device, the generated digital certificate and the digital fingerprint to establish a secure network connection with the second computing device, and the method 500 ends.

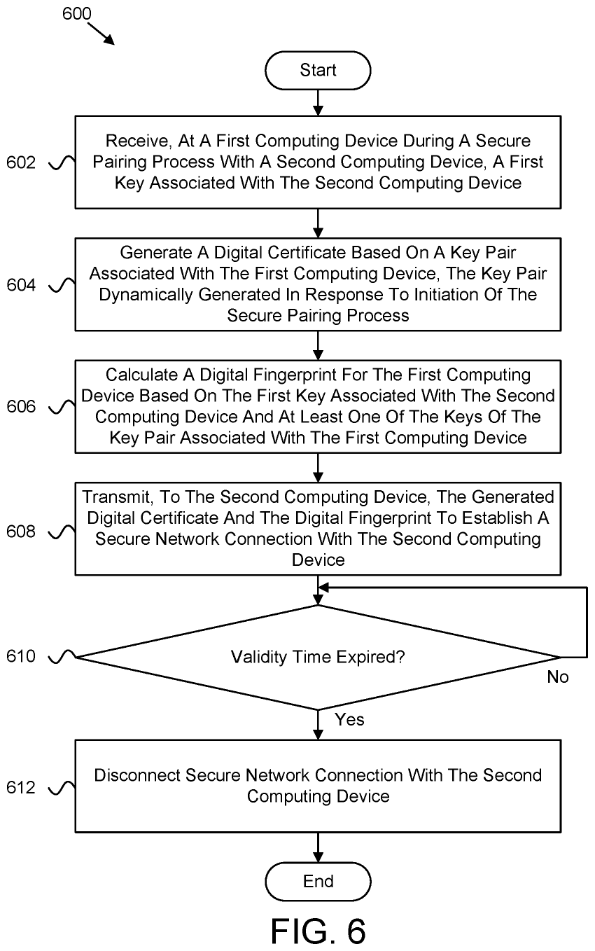

FIG. 6 is a schematic flow chart diagram illustrating one embodiment of another method 600 for secure device pairing. In one embodiment, the method 600 is performed by an information handling device 102, a plugin, a trust apparatus 104, a key module 202, a certificate generation module 204, a fingerprint calculation module 206, a transmission module 208, a timing module 402, a verification module 404, an FPGA, an ASIC, and/or any other computing device.

In one embodiment, the method 600 begins and receives 602, at a first computing device during a secure pairing process with a second computing device, a first key associated with the second computing device. In one embodiment, the method 600 generates 604 a digital certificate based on a key pair associated with the first computing device, the key pair dynamically generated in response to initiation of the secure pairing process. In one embodiment, the method 600 calculates 606 a digital fingerprint for the first computing device based on the first key associated with the second computing device and at least one of the keys of the key pair associated with the first computing device. In one embodiment, the method 600 transmits 608, to the second computing device, the generated digital certificate and the digital fingerprint to establish a secure network connection with the second computing device.

In one embodiment, the method 600 determines 610 whether a validity time period for the keys, the digital certificate, and/or the digital fingerprint has expired. If not, the method 600 maintains the secure network connection between the first and second devices and continues to check the validity time period of the keys, the digital certificate, and/or the digital fingerprint. Otherwise, if the method 600 determines 610 that the validity time period has expired, the method 600 disconnects 612 the secure network connection between the first and second computing devices, and the method 600 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a processor; and
a memory that stores code executable by the processor to:
receive, at the apparatus during a secure pairing process with a second computing device, a first key associated with the second computing device;
generate a digital certificate based on a key pair associated with the apparatus, the key pair dynamically generated in response to initiation of the secure pairing process;
calculate a digital fingerprint for the apparatus based on the first key associated with the second computing device and at least one of the keys of the key pair associated with the apparatus; and
transmit, to the second computing device, the generated digital certificate and the digital fingerprint to establish a secure network connection with the second computing device.

2. The apparatus of claim 1, wherein the code is further executable by the processor to:
receive, from the second computing device, a second digital certificate and a second digital fingerprint associated with the second computing device;
verify the second digital certificate and the second digital fingerprint based on the first key and the key pair; and
establish, in response to verifying the second the second digital certificate and the second digital fingerprint, the secure network connection with the second computing device.

3. The apparatus of claim 1, wherein the code is further executable by the processor to associate a validity time period with at least one of the key pair and the calculated digital fingerprint for the apparatus.

4. The apparatus of claim 3, wherein the code is further executable by the processor to invalidate the at least one of the key pair and the calculated digital fingerprint for the apparatus in response to expiration of the validity time period.

5. The apparatus of claim 4, wherein invalidation of the at least one of the key pair and the calculated digital fingerprint for the apparatus disconnects the secure network connection with the second computing device.

6. The apparatus of claim 1, wherein the code is further executable by the processor to invalidate the at least one of the key pair and the calculated digital fingerprint for the apparatus in response to disconnection of the secure network connection with the second computing device.

7. The apparatus of claim 1, wherein the secure pairing process is between a first plugin executing on the apparatus and a second plugin executing on the second computing device.

8. The apparatus of claim 1, wherein, in response to a request to initiate the secure pairing process with the second computing device, the code is further executable by the processor to generate the key pair for the apparatus, the key pair comprising a public key and a private key.

9. The apparatus of claim 8, wherein the code is further executable by the processor to transmit the public key for the apparatus to the second computing device.

10. The apparatus of claim 8, wherein the code is further executable by the processor to calculate a shared secret seed using a key agreement protocol between the apparatus and the second computing device, the key agreement protocol comprising an elliptic curve cryptography protocol.

11. The apparatus of claim 10, wherein the code is further executable by the processor to calculate a second key based on identifiers for the apparatus and the second computing device.

12. The apparatus of claim 11, wherein the code is further executable by the processor to generate the digital certificate using a key generated using elliptic curve cryptography (“ECC”) based on the second key and a dynamically determined generator ECC point.

13. The apparatus of claim 1, wherein the secure pairing process comprises a mutual transport layer security (“mTLS”) protocol.

14. A method, comprising:
receiving, at a first computing device during a secure pairing process with a second computing device, a first key associated with the second computing device;
generating a digital certificate based on a key pair associated with the first computing device, the key pair dynamically generated in response to initiation of the secure pairing process;
calculating a digital fingerprint for the first computing device based on the first key associated with the second computing device and at least one of the keys of the key pair associated with the first computing device; and
transmitting, to the second computing device, the generated digital certificate and the digital fingerprint to establish a secure network connection with the second computing device.

15. The method of claim 14, further comprising:
receiving, from the second computing device, a second digital certificate and a second digital fingerprint associated with the second computing device;
verifying the second digital certificate and the second digital fingerprint based on the first key and the key pair; and
establishing, in response to verifying the second the second digital certificate and the second digital fingerprint, the secure network connection with the second computing device.

16. The method of claim 14, further comprising associating a validity time period with at least one of the key pair and the calculated digital fingerprint for the first computing device.

17. The method of claim 16, further comprising invalidating the at least one of the key pair and the calculated digital fingerprint for the first computing device in response to expiration of the validity time period.

18. The method of claim 17, wherein invalidation of the at least one of the key pair and the calculated digital fingerprint for the first computing device disconnects the secure network connection with the second computing device.

19. The method of claim 14, further comprising invalidating the at least one of the key pair and the calculated digital fingerprint for the first computing device in response to disconnection of the secure network connection with the second computing device.

20. A program product comprising a computer readable storage medium that stores code executable by a processor, the executable code comprising code to:
receive, at a first computing device during a secure pairing process with a second computing device, a first key associated with the second computing device;
generate a digital certificate based on a key pair associated with the first computing device, the key pair dynamically generated in response to initiation of the secure pairing process;
calculate a digital fingerprint for the first computing device based on the first key associated with the second computing device and at least one of the keys of the key pair associated with the first computing device; and
transmit, to the second computing device, the generated digital certificate and the digital fingerprint to establish a secure network connection with the second computing device.
